(19) United States
(12) Patent Application Publication
(10) Pub. No.: US 2026/0211625 A1
(43) Pub. Date: Jul. 23, 2026

(54) FAST MODULAR MULTIPLICATION SYSTEM BASED ON RADIX TRANSFORMATION

(71) Applicant: Nanjing University, Nanjing (CN)

(72) Inventors: Jing Tian, Nanjing (CN); Yaodong Wei, Nanjing (CN); Minghao Li, Nanjing (CN); Zhongfeng Wang, Nanjing (CN)

(21) Appl. No.: 19/140,342

(22) PCT Filed: Dec. 2, 2024
(86) PCT No.: PCT/CN2024/136124

§ 371 Date: Jun. 17, 2025

(30) Foreign Application Priority Data
Dec. 4, 2023 (CN) 202311645720.9

(51) Int. Cl. G06F 7/72

(52) U.S. Cl. CPC G06F 7/722

(57) ABSTRACT

A fast modular multiplication system based on radix transformation, comprising: a pre-computation layer, configured to perform radix transformation processing on first and second modular multiplication inputs A and B that are input; a polynomial modular multiplication layer, configured to sequentially perform grouped multiplication processing and recombination and reduction processing on the radix-transformation-processed first and second modular multiplication inputs A and B; an iterative reduction layer, configured to perform sequentially wiring mapping processing and accumulation processing on the recombination-and-reduction-processed polynomials containing the first and second modular multiplication inputs A and B for several times; and a base restoration layer, configured to convert, from the base X to the binary, the polynomial containing the first and second modular multiplication inputs A and B.

### FIELD OF THE INVENTION

The invention relates to fields of computers and integrated circuits, particularly to a fast modular multiplication system based on radix transformation.

### BACKGROUND OF THE INVENTION

With fast development of quantum computing technology, the widely used conventional public-key cryptographic system today, which is based on integer factorization and discrete logarithm problems, are vulnerable to being broken by quantum computers, which would severely undermine the security, confidentiality, and integrity of digital communications. In recent years, the cryptographic community has actively researched new public-key cryptographic systems, known as “post-quantum cryptography”, designed to resist quantum computing attacks. Among these, lattice-based encryption algorithms have received significant attention as one of the most promising post-quantum cryptographic approaches, owing to their strong security properties and other advantages. Both academic and industrial communities have conducted extensive research on the optimization of these algorithms.

In lattice-based cryptography, a modular multiplication operation is one of the most critical operations, occupying the majority of computational time and hardware resources in the cryptographic system. Optimizing modular multiplication can significantly improve the overall efficiency of the system. Typically, the modular multiplication is implemented in two ways: −1. Non-interleaved Modular Multiplication, in which multiplication and reduction are performed independently in a “multiply first, then reduce” manner. The reduction process is relatively complex and serves as the primary focus for optimization. Common reduction algorithms include Montgomery reduction algorithm and Barrett reduction algorithm. Additionally, an existing “lookup-table-accumulation” method is highly effective for modulus operations in finite fields of lattice-based cryptography. −2. Interleaved Modular Multiplication, which combines multiplication and reduction in a “multiply-and-reduce simultaneously” manner, known as Montgomery modular multiplication algorithm.

General description of reduction method based on a lookup-table-accumulation is summarized as follows.

A bit width of a fixed modulus q may be denoted by ┌log₂ q┐=N. Then, q may be expressed as follows.

$$q = {2}^{N} - δ ( 1 \leq δ < {2}^{N - 1} )$$

Then, the following is obtained.

$${2}^{N} ≡ δ ( mod q )$$

The following exists for a to-be-reduced number z[D−1:0] (D>N).

$$\begin{matrix}z ≡ z [ D - 1 : N ] \cdot {2}^{N} + z [ N - 1 : 0 ] \\ ≡ z [ D - 1 : N ] \cdot δ + z [ N - 1 : 0 ] \\ ≡ {z}^{′} [ {D}^{′} - 1 : {N}^{′} ] \cdot {2}^{N} + {z}^{′} [ {N}^{′} - 1 : 0 ] + z [ N - 1 : 0 ] \\ ≡ {z}^{′} [ {D}^{′} - 1 : {N}^{′} ] \cdot δ + {z}^{′} [ {N}^{′} - 1 : 0 ] + z [ N - 1 : 0 ] \\ ≡ … ( mod q )\end{matrix}$$

Based on the above description, the modulus q to which reduction method based on a lookup-table-accumulation is applicable generally has two features: (1) a δ value is small, i.e., the bit width is small; and (2) a Hamming weight of the δ is low, i.e., there are not many non-zero bits. This method can rapidly reduce bit width to complete modular operation. Compared to traditional Barrett and Montgomery algorithms, it saves additional multiplication overhead, reduces area, and lowers latency, as a highly effective reduction technique. However, limitation of such a method is also quite obvious. In a not-very-ideal situation (large or a high Hamming weight of the δ), the reduction process faces a great number of reduction iterations and complex connections, leading to increase of both the area and time complexity. Consequently, few practical moduli can effectively employ this method.

### SUMMARY OF THE INVENTION

The application provides a fast modular multiplication system based on radix transformation, capable of solving the problem of a great number of reduction iterations and complex connections in a lattice-based cryptographic system in prior art.

The fast modular multiplication system includes:
a pre-computation layer, configured to perform radix transformation processing on first and second modular multiplication inputs A and B that are input, to convert the first and second modular multiplication inputs A and B obtained based on a modulus q from binary to a base-X;
a polynomial modular multiplication layer, comprising a plurality of adders and multipliers, and configured to sequentially perform, through the adders and multipliers built therein, grouped multiplication processing and recombination and reduction processing on intermediate value coefficients of the radix-transformation-processed first and second modular multiplication inputs A and B, to reduce degrees of the resultant polynomial of the first and second modular multiplication inputs A and B;
an iterative reduction layer, comprising a plurality of iterative reduction sub-layers each having a plurality of adders, and configured to sequentially perform, through the adders built therein, wiring mapping processing and accumulation processing on the recombination-and-reduction-processed polynomials containing the first and second modular multiplication inputs A and B for several times, to reduce bit widths of coefficients of a (n−1)-degree polynomial of X containing the first and second modular multiplication inputs A and B; and
a base restoration layer, configured to convert, from the base X to the binary, the polynomial containing the first and second modular multiplication inputs A and B on which a last time of accumulation processing has been performed, to obtain an actual modular multiplication result.

Preferably, the pre-computation layer is further configured to:
set the modulus q in a modular multiplication operation, a bit width N of the modulus q, and the first and second modular multiplication inputs A and B;
transform, according to a radix transformation formula, the first and second modular multiplication inputs A and B into a polynomial of X, the radix transformation formula being X=2^{α}−1, wherein a is a positive integer, and α<N, the polynomial of X being q(X)=kXⁿ−δ(X); and
obtain first target polynomials according to the polynomial of X, the first target polynomials consisting of initial polynomials of the first and second modular multiplication inputs A and B, respectively as follows.

An initial polynomial of the modulus q may be kXⁿ mod q=δ(X).

The initial polynomial of the first modular multiplication input A may be

$$A ( X ) = {\sum }_{i = 0}^{n - 1} {\overline{a}}_{i} {X}^{i} = {( {\overline{a}}_{n - 1} , {\overline{a}}_{n - 2} , … {\overline{a}}_{i} , … {\overline{a}}_{1} , {\overline{a}}_{0} )}_{X} .$$

The initial polynomial of the second modular multiplication input B may be

$$B ( X ) = {\sum }_{i = 0}^{n - 1} {\overline{b}}_{ι} {X}^{i} = {( {\overline{b}}_{n - 1} , {\overline{b}}_{n - 2} , … {\overline{b}}_{i} , … {\overline{b}}_{1} , {\overline{b}}_{0} )}_{X} .$$

δ(X) may be a polynomial regarding X,

$$δ ( X ) = {\sum }_{i = 0}^{n - 1} {r}_{i} {X}^{i} , \vert {r}_{i} \vert ( i = 0 , 1 , 2 … ) ,$$

āᵢ and b̅ᵢ may be coefficients of polynomials A(X), B(X), respectively, i may be constants.

Preferably, the polynomial modular multiplication layer further includes: a grouped multiplication layer and a recombination and reduction layer.

The grouped multiplication layer may include a plurality of adders and multipliers. The recombination and reduction layer may include a plurality of adders.

The grouped multiplication layer may be configured to perform grouped multiplication processing on the first target polynomials, to obtain a second target polynomial.

The recombination and reduction layer may be configured to perform recombination and reduction processing on the second target polynomial, to obtain a (n−1)-degree polynomial of X.

Preferably, the grouped multiplication layer is further configured to:
transform, through the adders and multipliers built therein, a computing relation in the first target polynomials from constant multiplication to polynomial multiplication, and single multiplication to grouped multiplication, to obtain the second target polynomial.

Preferably, the recombination and reduction layer is further configured to:
perform, through adders built therein, recombination and merging processing on the second target polynomial, to obtain a recombined polynomial;
perform reduction processing on the recombined polynomial, to obtain a reduced polynomial; and
put the reduced polynomial into the initial polynomial of the modulus q for plurality of times, to obtain the (n−1)-degree polynomial of X.

Preferably, the second target polynomial is

$${c}_{i} = {\sum }_{k = 0}^{i} {\overline{a}}_{k} {\overline{b}}_{i - k} ;$$

the recombined polynomial is:

$$C = {\sum }_{i = 0}^{2 n - 2} {c}_{i} {X}^{{i}^{\underline{\underline{{t}_{i} = {c}_{i} / k}}}} {kX}^{n} {\sum }_{i = n}^{2 n - 2} {t}_{i} {X}^{i - n} + {\sum }_{i = 0}^{n - I} {c}_{i} {X}^{i} ;$$

the reduced polynomial is:

$$C mod q ≡ δ ( X ) {\sum }_{i = n}^{2 n - 2} {t}_{i} {X}^{i - n} + {\sum }_{i = 0}^{n - 1} {c}_{i} {X}^{i} ;$$

and
the (n−1)-degree polynomial of X is:

$$Cmodq ≡ {\sum }_{i = 0}^{n - 1} {u}_{i} {X}^{i} ,$$

wherein uᵢ is a new polynomial coefficient obtained by accumulating terms of the polynomial for a plurality of terms, a bit width of uᵢ is denoted by Nᵤ_{ᵢ} bits, and N<Nᵤ_{ᵢ}<2N; cᵢ is a coefficient of 2M bits; n is a constant; āᵢ is of Mbits; b̅ᵢ is a coefficient of M bits, and k is a coefficient of a highest-degree term.

Preferably, each of the iterative reduction sub-layer includes a wiring-mapping layer and an accumulation layer. The accumulation layer may include a plurality of adders.

The wiring-mapping layer may be configured to perform wiring-mapping processing on the (n−1)-degree polynomial of X.

The accumulation layer may be configured to perform accumulation processing on the (n−1)-degree polynomial of X on which wiring-mapping processing has been performed once.

Preferably, the iterative reduction layer is further configured to:
perform sequentially, through the adders built therein, wiring-mapping processing and accumulation processing on the recombination-and-reduction processed (n−1)-degree polynomial of X for a plurality of times; and
output a third target polynomial in response to the bit widths of coefficients of the (n−1)-degree polynomial of X each being reduced to a required range.

Preferably, the iterative reduction layer is further configured to:
transform the recombination-and-reduction processed (n−1)-degree polynomial of X into a polynomial in a uᵢ form satisfying uᵢ[Nᵤ_{ᵢ}−1:0]=uᵢ[Nᵤ_{ᵢ}−1:L]·(X+1)·2^{L-α}+uᵢ[L−1:0]; and
put the polynomial in the uᵢ form into the initial polynomial of the modulus q and the (n−1)-degree polynomial of X for a plurality of times for reduction, to obtain the third target polynomial satisfying

$$Cmodq ≡ {\sum }_{i = 0}^{n - 1} {z}_{i} {X}^{i} = {( {z}_{n - 1} , {z}_{n - 2} , … {z}_{i} , … {z}_{1} , {z}_{0} )}_{X} ,$$

wherein zᵢ are coefficients.

Preferably, the base restoration layer is further configured to:
perform addition and shift operations on the third target polynomial for a plurality of times, to obtain the actual modular multiplication result.

The application provides a fast modular multiplication system based on radix transformation, including: a pre-computation layer, configured to perform radix transformation processing on an input modulus q, to convert the modulus q from binary to a base-X; a polynomial modular multiplication layer, comprising a plurality of adders and multipliers, and configured to sequentially perform, through the adders and multipliers built therein, grouped multiplication processing and recombination and reduction processing on the radix-transformation-processed modulus q, to reduce degrees of polynomial containing the modulus q; an iterative reduction layer, comprising a plurality of iterative reduction sub-layers each having a plurality of adders, and configured to sequentially perform, through the adders built therein, wiring mapping processing and accumulation processing on the recombination-and-reduction-processed polynomials containing the modulus q for several times, to reduce bit widths of coefficients of a (n−1)-degree polynomial of X containing the modulus q; and a base restoration layer, configured to convert, from the base X to the binary, the polynomial containing the modulus q on which a last time of accumulation processing has been performed, to obtain an actual modular multiplication result. The application utilizes the aforementioned fast modular multiplication system to reduce circuit hardware usage and save circuit area, and achieves superior area and speed performance compared to conventional modular multiplication systems.

### BRIEF DESCRIPTION OF THE DRAWINGS

FIG. 1 is a schematic diagram of a fast modular multiplication system based on radix transformation according to the application.

FIG. 2 is a logic flowchart of a fast modular multiplication system based on radix transformation according to the application.

FIG. 3 is a schematic diagram of a process of executing a plurality of modular multiplications by a fast modular multiplication system based on radix transformations according to the application.

### DETAILED DESCRIPTION OF THE EMBODIMENTS

It is noted that a concept of “layer” mentioned herein may be referred to as “unit” or “module”, which should be regarded as a structure composed of multiple hardware components with specific function. When describing the specific composition of respective layers, in addition to reference to hardware components contained in the structure of respective layers, the functionalities of the hardware components are described with reference to the methods executed by software configurations on the hardware components.

In this embodiment, the primary hardware components constituting the layered hardware architectures include adders and a multiplier. The adder is an electronic circuit configured to execute an operation of binary addition, capable of processing two and more addition operations. The adder may be categorized into a single-bit adder, a multi-bit adder, etc. depending on bits. In practice, multiple adders can be combined into an adder array based on predefined logical operations to enable higher-bit width addition. A multiplier is an electronic circuit or device configured to execute an operation of multiplication of two binary numbers. A multiplier is based on an adder structure, and may essentially be regarded as a device to implement an algorithm for “shift and addition”. A multiplier may be categorized into a single-bit multiplier, a multi-bit multiplier, etc. depending on bits processed. In practice, multiple multipliers may constitute a multi-bit multiplier to enable higher-bit width multiplication.

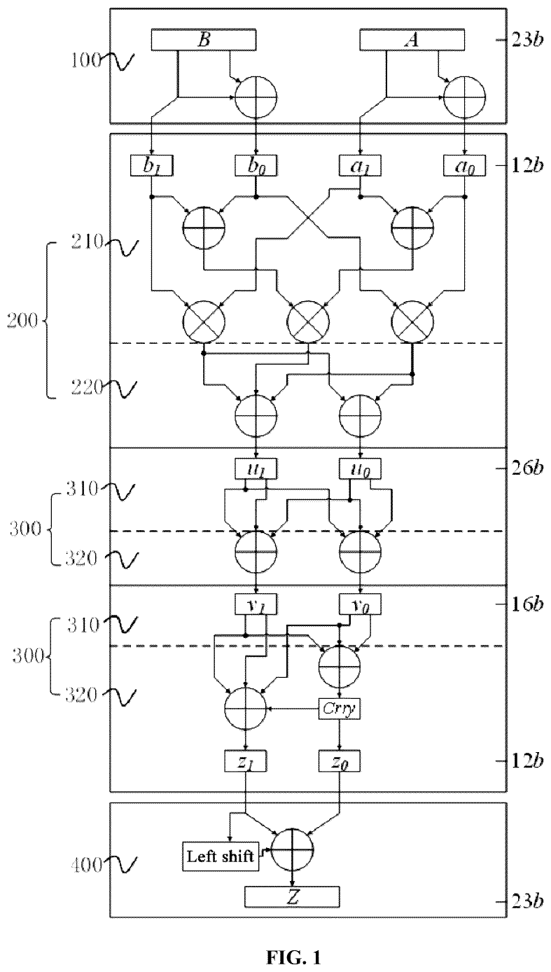

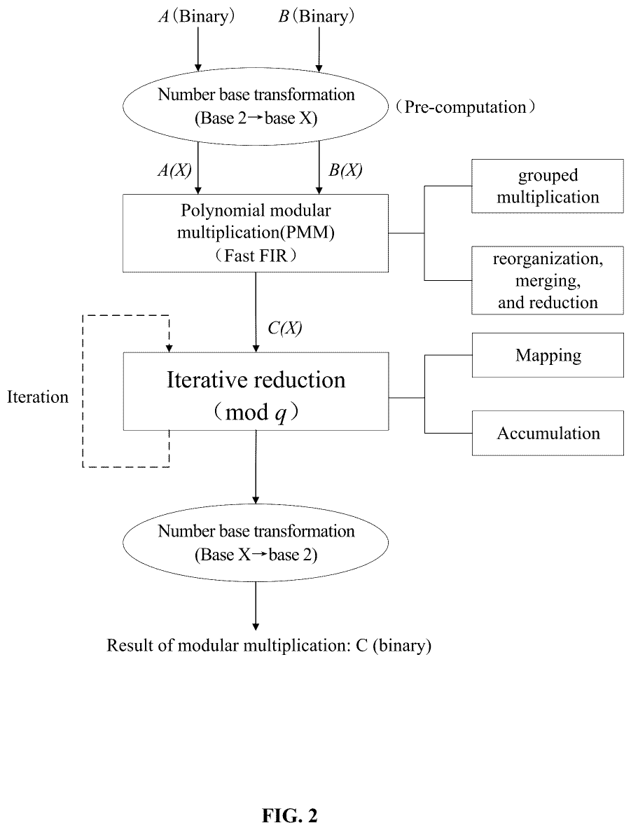

Referring to FIG. 1 and FIG. 2, embodiments herein provide a fast modular multiplication system based on radix transformation, comprising:

A pre-computation layer 100, configured to perform radix transformation processing on first and second modular multiplication inputs A and B that are input, to convert the first and second modular multiplication inputs A and B obtained based on a modulus q from binary to a base-X. Specifically, in the embodiments, unlike a conventional binary denotation method, with a solution herein, radix transformation is to be performed on the modulus and the inputs before modular multiplication. Through the pre-computation layer 100, the modulus q in a modular multiplication operation, a bit width N of the modulus q, the first and second modular multiplication inputs A and B may be set; and the first and second modular multiplication inputs A and B may be transformed into a polynomial of X according to a radix transformation formula. The radix transformation may be in form of X=2^{α}−1, wherein α may be a positive integer, and α<N. The polynomial of X may be q(X)=kXⁿ−δ(X), wherein n is an order of q (X) after conversation to X, k is a coefficient of a highest-degree term. In addition, first target polynomials may be obtained according to the polynomial of X, to perform radix transformation on the first and second modular multiplication inputs A and B.

The pre-computation layer 100 may implement a foregoing function through a structure composed of low-latency adders, thereby increasing an operation speed. To further improve an operation efficiency, the low-latency adder may be combined to reduce a critical path length of a multiplier in modular multiplication.

It is noted that an α value may be selected following two principles: making a “Hamming weight” of a δ(X) coefficient be as small as possible, i.e., making |rᵢ|(i=0, 1, 2 . . . ) be as small as possible and be 0, thus reducing connection complexity; and making a binary bit width of δ(X) be as small as possible, thus reducing a number of subsequent iterations.

A specific process is as follows.

The inputs of radix transformation are two binary numbers on which modular multiplication is to be performed, i.e.,

$$A [ N - 1 : 0 ] = {\sum }_{i = 0}^{N - 1} {a}_{i} {2}^{i} = {( {a}_{N - 1} , {a}_{N - 2} , … {a}_{i} , … {a}_{1} , {a}_{0} )}_{2} and$$

$$B [ N - 1 : 0 ] = {\sum }_{i = 0}^{N - 1} {b}_{i} {2}^{i} = {( {b}_{N - 1} , {b}_{N - 2} , … {b}_{i} , … {b}_{1} , {b}_{0} )}_{2} ,$$

which are respectively transformed into n numbers (n coefficients of an initial polynomial) after passing through 100 layers.

An initial polynomial of the modulus q may be kXⁿ mod q=δ(X). Then,
the initial polynomial of the first modular multiplication input A may be

$$A ( X ) = {\sum }_{i = 0}^{n - 1} {\overline{a}}_{i} {X}^{i} = {( {\overline{a}}_{n - 1} , {\overline{a}}_{n - 2} , … {\overline{a}}_{i} , … {\overline{a}}_{1} , {\overline{a}}_{0} )}_{X} ,$$

and
the initial polynomial of the second modular multiplication input B may be

$$B ( X ) = {\sum }_{i = 0}^{n - 1} {\overline{b}}_{ι} {X}^{i} = {( {\overline{b}}_{n - 1} , {\overline{b}}_{n - 2} , … {\overline{b}}_{i} , … {\overline{b}}_{1} , {\overline{b}}_{0} )}_{X} .$$

wherein δ(X) may be a polynomial regarding X.

$$δ ( X ) = {\sum }_{i = 0}^{N - 1} {r}_{i} {X}^{i} , \vert {r}_{i} \vert ( i = 0 , 1 , 2 … ) .$$

āᵢ and b̅ᵢ may De coefficients of polynomials A(X) and B(X), respectively, and i may be constants.

It is noted that the first and second modular multiplication input A and B have the same bit width as the modulus q, i.e., N.

It is noted that the modulus q may be determined as needed. Illustratively, different moduli q are formulated for data of fields such as a bank encryption system, exchange encryption, etc.

The fast modular multiplication system further includes a polynomial modular multiplication layer 200.

The polynomial modular multiplication layer 200 includes a plurality of adders and multipliers. The polynomial modular multiplication layer 200 is configured to sequentially perform, through the adders and multipliers built therein, grouped multiplication processing and recombination and reduction processing on intermediate value coefficients of the radix-transformation-processed first and second modular multiplication inputs A and B, to reduce degrees of polynomials containing the first and second modular multiplication inputs A and B. Specifically, in embodiments herein, a fast finite impulse response (FIR) algorithm combination is performed on the radix-transformation-processed polynomial, to decrease an amount of multipliers used, thus reducing area of a circuit.

The polynomial modular multiplication layer 200 may further include a grouped multiplication layer 210 and a recombination and reduction layer 220. The grouped multiplication layer 210 may include a plurality of adders and multipliers. The recombination and reduction layer may include a plurality of adders.

In embodiments herein, grouped multiplication processing may be performed on the first target polynomials through the grouped multiplication layer 210, to obtain a second target polynomial. Specifically, the grouped multiplication layer 210 is further configured to transform, through adders and multipliers built therein, a computing relation in the first target polynomials from constant multiplication to polynomial multiplication, and single multiplication to grouped multiplication, to obtain the second target polynomial. The multipliers may be configured to execute an operation of polynomial multiplication. The adders may be configured to compute an intermediate result for the operation of multiplication.

In embodiments herein, recombination and reduction processing is performed on the second target polynomial through the recombination and reduction layer 220, to obtain a (n−1)-degree polynomial of X. Specifically, the recombination and reduction layer 220 performs, through adders built therein, recombination and merging processing on the second target polynomial, to obtain a recombined polynomial, and perform reduction processing on the recombined polynomial, to obtain a reduced polynomial, and finally put the reduced polynomial into the initial polynomial of the modulus q for plurality of times, to obtain the (n−1)-degree polynomial of X.

The adders not only may compute a result of a current bit, but also pass a carry signal to a next bit, to implement an operation of continuous addition. In addition to a basic addition operation, the adders may further implement other logic operations such as XOR, NAND, etc., through different combinations of logic gates. These operations may be used for specific data transformation or verification in recombination and reduction processing.

The second target polynomial may be

$${c}_{i} = {\sum }_{k = 0}^{i} {\overline{a}}_{k} {\overline{b}}_{i - k} .$$

The recombined polynomial may be:

$$C = {\sum }_{i = 0}^{2 n - 2} {c}_{i} {X}^{{i}^{\underline{\underline{{t}_{i} = {c}_{i} / k}}}} {kX}^{n} {\sum }_{i = n}^{2 n - 2} {t}_{i} {X}^{i - n} + {\sum }_{i = 0}^{n - 1} {c}_{i} {X}^{i} .$$

The reduced polynomial may be:

$$Cmodq ≡ δ ( X ) {\sum }_{i = n}^{2 n - 2} {t}_{i} {X}^{i - n} + {\sum }_{i = 0}^{n - 1} {c}_{i} {X}^{i} .$$

The (n−1)-degree polynomial of X may be:

$$Cmodq ≡ {\sum }_{i = 0}^{n - 1} {u}_{i} {X}^{i} .$$

Wherein uᵢ may be a new polynomial coefficient obtained by accumulating terms of the polynomial for a plurality of terms, a bit width of uᵢ may be denoted by Nᵤ_{ᵢ} bits, and N<Nᵤ_{ᵢ}<2N; cᵢ may be a coefficient of 2M bits, n may be a constant, āᵢ may be of M bits, and b̅ᵢ may be a coefficient of M bits.

In embodiments herein, a fast FIR algorithm is applied to the polynomial multiplication, reducing the number of multipliers effectively. The fast FIR algorithm is an algorithm configured to improve computational efficiency in digital signal processing. A core idea thereof is to reduce the number of multiplications by decomposing and recombining FIR filtering units, at a price of the increased number of additions. As a multiplier has higher complexity than an adder, reducing the number of multiplications may effectively improve computational efficiency of a convolution operation. The fast FIR algorithm may also applied to a polynomial multiplication operation. In conventional multiplication of two order-(N−1) polynomials, N² multiplications have to be performed, while in theory applying 2 parallel and 3 parallel fast FIR algorithms need only ¾ N² and ⅔ N² multiplications, saving a hardware overhead by nearly 25% and 33.3%, respectively. For example, if N=2, using 2 parallel fast FIR, an expression may be expanded as follows.

$$( {a}_{1} X + {a}_{0} ) ( {b}_{1} X + {b}_{0} ) = {a}_{1} {b}_{1} ( {X}^{2} ) + [ ( {a}_{1} + {a}_{0} ) ( {b}_{1} + {b}_{0} ) - {a}_{1} {b}_{1} - {a}_{0} {b}_{0} ] ( X ) + {a}_{0} {b}_{0}$$

A plurality of multiplications required may be reduced from 4 to 3 at a price of the increased number of adders from 1 to 4.

Specifically, the polynomial modular multiplication layer 200 essentially performs readjustment of connection on outputs of multipliers of a preceding stage, and then connection-readjusted outputs serve as inputs to n adders. Outputs of the n adders may be denoted by uᵢ (i=0, 1, 2 . . . n−1), with the bit width being Nᵤ_{ᵢ} bits, and N<Nᵤ_{ᵢ}<2N.

Specifically, the result of the foregoing modular multiplication is insufficiently reduced. For further reduction, uᵢ may also be denoted by polynomials of X:

$${u}_{i} [ {N}_{{u}_{i}} - 1 : 0 ] = {u}_{i} [ {N}_{{u}_{i}} - 1 : L ] \cdot {2}^{L} + {u}_{i} [ L - 1 : 0 ]$$

$${u}_{i} [ {N}_{{u}_{i}} - 1 : 0 ] = {u}_{i} [ {N}_{{u}_{i}} - 1 : L ] \cdot ( {2}^{α} - 1 + 1 ) \cdot {2}^{L - α} + {u}_{i} [ L - 1 : 0 ]$$

$${u}_{i} [ {N}_{{u}_{i}} - 1 : 0 ] = {u}_{i} [ {N}_{{u}_{i}} - 1 : L ] \cdot ( X + 1 ) \cdot {2}^{L - α} + {u}_{i} [ L - 1 : 0 ] ;$$

wherein α<L<Nᵤ_{ᵢ}·uᵢ may be put back into the original formula, and the initial polynomial of the modulus q and the (n−1)-degree polynomial of X may be applied repeatedly. The process essentially performs bit recombination and merging on the coefficients, and obtains a new round of coefficients after some wiring-mapping and accumulation, to achieve the goal of reduction. The foregoing process may be iterated, and the final goal is to reduce bit widths of coefficients of an order-(n−1) polynomial regarding X to within a required range, i.e., a.

The fast modular multiplication system further includes an iterative reduction layer 300.

The iterative reduction layer 300 includes a plurality of iterative reduction sub-layers, each having a plurality of adders, and configured to sequentially perform, through the adders built therein, wiring mapping processing and accumulation processing on the recombination-and-reduction-processed polynomials containing the first and second modular multiplication inputs A and B for several times, to reduce bit widths of coefficients of a (n−1)-degree polynomial of X containing the modulus q, so as to simplify a representation form of the polynomial. Specifically, in embodiments herein, the bit widths of the coefficients of the modulus-containing (n−1)-degree polynomial of X are shortened through the iterative reduction layer 300.

The iterative reduction sub-layer may include a wiring-mapping layer 310 and an accumulation layer 320. The accumulation layer 320 may include a plurality of adders. Through the wiring-mapping layer 310, wiring-mapping processing may be performed on the (n−1)-degree polynomial of X. Through the accumulation layer 320, accumulation processing may be performed on the (n−1)-degree polynomial of X on which wiring-mapping processing has been performed once.

In embodiments herein, the iterative reduction layer 300 is used to perform sequentially wiring-mapping processing and accumulation processing on the recombination-and-reduction processed (n−1)-degree polynomial of X for a plurality of times through the adders built therein; and a third target polynomial is output in response to the bit widths of coefficients of the (n−1)-degree polynomial of X each being reduced to a required range, to complete reduction of the bit widths of the coefficients of the (n−1)-degree polynomial of X. The iterative reduction layer 300 may complete reduction of the bit widths of the coefficients of the (n−1)-degree polynomial of X specifically as follows.

The recombination-and-reduction processed (n−1)-degree polynomial of X is transformed into a polynomial in a uᵢ form satisfying uᵢ[Nᵤ_{ᵢ}−1:0]=uᵢ[Nᵤ_{ᵢ}−1:L]·(X+1)·2^{L-α}+uᵢ[L−1:0]; and the polynomial in the u; form is put into the initial polynomial of the modulus q and the (n−1)-degree polynomial of X for the plurality of times for reduction, to obtain the third target polynomial. The third target polynomial may be

$$Cmodq ≡ {\sum }_{i = 0}^{n - 1} {z}_{i} {X}^{i} = {( {z}_{n - 1} , {z}_{n - 2} , … {z}_{i} , … {z}_{1} , {z}_{0} )}_{X} ,$$

wherein zᵢ may be coefficients and a bit width is α.

The fast modular multiplication system further includes a base restoration layer 400.

The base restoration layer 400 is configured to convert, from the base X to the binary, the polynomial containing the first and second modular multiplication inputs A and B on which a last time of accumulation processing has been performed, to obtain an actual modular multiplication result. Specifically, in embodiments herein, through the base restoration layer 400, a plurality of addition and shift operations are performed on the third target polynomial, to obtain the actual modular multiplication result.

Illustratively, an overall embodiment for a solution herein is as follows.

Assume that the modulus q[22:0]=8380417. A new base number X=2¹¹−1 is selected, and then, q=2X²−1, and there is further:

$$2 {X}^{2} modq = 1 , \qquad ( 3 )$$

wherein the modulus q is a modulus selected by a lattice-based cryptography CRYSTALS-Dilithium, which is standardized.

Assume that modular multiplication inputs are A[22:0] and B[22:0], respectively. To facilitate subsequent reduction, A and B may be expressed using polynomials containing X as follows.

$$A = {a}_{1} 2 X + {a}_{0}$$

$$B = {b}_{1} 2 X + {b}_{0}$$

Wherein a₁, a₀, b₁, b₀ are each a 12-bit bit width. Assume that a result of multiplication is C[45:0].

$$C = A \cdot B = ( {a}_{1} 2 X + {a}_{0} ) ( {b}_{1} 2 X + {b}_{0} )$$

The formula may be expanded using the fast FIR algorithm and organized to obtain:

$$C = 2 {a}_{1} {b}_{1} ( 2 {X}^{2} ) + [ ( {a}_{1} + {a}_{0} ) ( {b}_{1} + {b}_{0} ) - {a}_{1} {b}_{1} - {a}_{0} {b}_{0} ] ( 2 X ) + {a}_{0} {b}_{0}$$

A first reduction may be performed on C using the formula (3).

$$C mod q ≡ [ ( {a}_{1} + {a}_{0} ) ( {b}_{1} + {b}_{0} ) - {a}_{1} {b}_{1} - {a}_{0} {b}_{0} ] ( 2 X ) + 2 {a}_{1} {b}_{1} + {a}_{0} {b}_{0}$$

A maximum bit width of [(a₁+a₀)(b₁+b₀)-a₁b₁-a₀b₀] is 25 bits, and a maximum bit width of (2a₁b₁+a₀b₀) is 26 bits, which may be denoted by u₁[24:0], u₀[25:0], respectively, and there is further,

$$C mod q ≡ {u}_{1} [ 24 : 0 ] ( 2 X ) + {u}_{0} [ 25 : 0 ]$$

Coefficients of C may be rearranged and organized to obtain:

$$C mod q ≡ ( {u}_{1} [ 24 : 15 ] \cdot {2}^{15} + {u}_{1} [ 14 : 0 ] ) ( 2 X ) + {u}_{0} [ 25 : 14 ] \cdot {2}^{14} + {u}_{0} [ 13 : 0 ] ≡ ( {u}_{1} [ 24 : 15 ] ( 16 X + 16 ) + {u}_{1} [ 14 : 0 ] ) ( 2 X ) + ( {u}_{0} [ 25 : 14 ] ( 8 X + 8 ) + {u}_{0} [ 13 : 0 ] ≡ ( 16 {u}_{1} [ 24 : 15 ] + {u}_{1} [ 14 : 0 ] + 4 {u}_{0} [ 25 : 14 ] ( 2 X ) + 16 {u}_{1} [ 25 : 15 ] + 8 {u}_{0} [ 25 : 14 ] + {u}_{0} [ 13 : 0 ]$$

In the same way, let

$${v}_{1} [ 15 : 0 ] = 16 {u}_{1} [ 24 : 15 ] + {u}_{1} [ 14 : 0 ] + 4 {u}_{0} [ 25 : 14 ]$$

$${v}_{0} [ 15 : 0 ] = 16 {u}_{1} [ 24 : 15 ] + 8 {u}_{0} [ 25 : 14 ] + {u}_{0} [ 13 : 0 ]$$

The following may be obtained:

$$C mod q ≡ {v}_{1} [ 15 : 0 ] ( 2 X ) + {v}_{0} [ 15 : 0 ] ≡ ( {v}_{1} [ 15 : 11 ] ( X + 1 ) + {v}_{1} [ 10 : 0 ] ( 2 X ) + {v}_{0} [ 15 : 12 ] ( 2 X + 2 ) + {v}_{0} [ 11 : 0 ] ≡ ( {v}_{1} [ 15 : 11 ] + {v}_{1} [ 10 : 0 ] + {v}_{0} [ 15 : 12 ] ( 2 X ) + {v}_{1} [ 15 : 11 ] + 2 {v}_{0} [ 15 : 12 ] + {v}_{0} [ 11 : 0 ] ≡ {w}_{1} [ 11 : 0 ] ( 2 X ) + {w}_{0} [ 12 : 0 ] ≡ ( {w}_{1} [ 11 : 0 ] + {w}_{0} [ 12 ] ( 2 X ) + 2 {w}_{0} [ 12 ] + {w}_{0} [ 11 : 0 ]$$

Embodiments herein have advantages as follows.

A solution herein is more universal by performing radix transformation on a modulus where conventionally the lookup-table-accumulation method cannot apply.

After radix transformation, data is transformed into polynomial expressions, which thus may be combined with the fast FIR algorithm, to further reduce the number of multiplications through reuse, reducing the area of the circuit.

An architecture of interleaved modular multiplication and an interleaved architecture of modular grouped multiplication are proposed, with a reduction part that avoids multiplier usage compared to a conventional method and is formed by a cascade of layers of adders, greatly reducing hardware resource and computational latency.

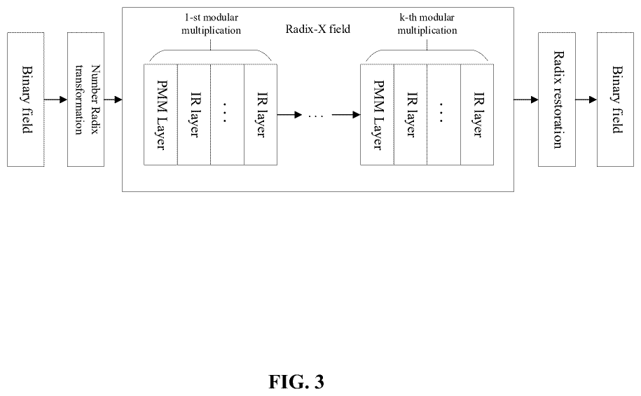

In addition, with a hardware structure composed of the foregoing pre-computation layer 100, the polynomial modular multiplication layer 200, the iterative reduction layer 300, and the base restoration layer 400, in implementing specific data computation, steps executed by the pre-computation layer 100 and the base restoration layer 400 are equivalent to transforming a polynomial operation from a binary field to a base-X field. That is, to perform an operation of plurality of modular multiplications on data, it only requires to perform layer operations of the polynomial modular multiplication layer 200 and the iterative reduction layer 300 for a plurality of times, and operations at the pre-computation layer 100 and the base restoration layer 400 just have to be performed once, respectively (as shown in FIG. 3), which can further reduce latency due to plurality of modular multiplications.

The fast modular multiplication system according to embodiments of the application not only implements an original computational effect and an original computational precision, but also simplifies a hardware structure, therefore more advantageous in terms of a circuit area and a processing speed, compared to a structure of a conventional system for modular multiplication.

1. A fast modular multiplication system based on radix transformation, wherein the fast modular multiplication system comprises:
a pre-computation layer, configured to perform radix transformation processing on first and second modular multiplication inputs A and B obtained based on a modulus q, to convert the first and second modular multiplication inputs A and B from binary to a base-X;
a polynomial modular multiplication layer, comprising a plurality of adders and multipliers, said polynomial modular multiplication layer configured to sequentially perform, through the adders and multipliers built therein, grouped multiplication processing and recombination and reduction processing on intermediate value coefficients of the radix-transformation-processed first and second modular multiplication inputs A and B, to reduce degrees of resultant polynomial of the first and second modular multiplication inputs A and B;
an iterative reduction layer, comprising a plurality of iterative reduction sub-layers each having a plurality of adders, said iterative reduction layer configured to sequentially perform, through the adders built therein, wiring mapping processing and accumulation processing on the recombination-and-reduction-processed polynomials containing the first and second modular multiplication inputs A and B for several times, to reduce bit widths of coefficients of a (n−1)-degree polynomial of X containing the first and second modular multiplication inputs A and B; and
a base restoration layer, configured to convert, from the base X to the binary, the polynomial containing the first and second modular multiplication inputs A and B on which a last time of accumulation processing has been performed, to obtain an actual modular multiplication result.

2. The fast modular multiplication system based on radix transformation according to claim 1, wherein the pre-computation layer is further configured to:
set the modulus q in a modular multiplication operation, a bit width N of the modulus q, and the first and second modular multiplication inputs A and B;
transform, according to a radix transformation formula, the first and second modular multiplication inputs A and B into a polynomial of X, the radix transformation formula being X=2^{α}−1, wherein a is a positive integer, and α<N, the polynomial of X being q(X)=kXⁿ−δ(X); and
obtain first target polynomials according to the polynomial of X, the first target polynomials comprising an initial polynomials of the first and second modular multiplication inputs A and B, respectively as follows,
an initial polynomial of the modulus q being kXⁿ mod q=δ(X),
the initial polynomial of the first modular multiplication input A being
$$A ( X ) = {\sum }_{i = 0}^{n - 1} {\overline{a}}_{i} {X}^{i} = {( {\overline{a}}_{n - 1} , {\overline{a}}_{n - 2} , … {\overline{a}}_{i} , … {\overline{a}}_{1} , {\overline{a}}_{0} )}_{X} ,$$
the initial polynomial of the second modular multiplication input B being
$$B ( X ) = {\sum }_{i = 0}^{n - 1} {\overline{b}}_{i} {X}^{i} = {( {\overline{b}}_{n - 1} , {\overline{b}}_{n - 2} , … {\overline{b}}_{i} , … {\overline{b}}_{1} , {\overline{b}}_{0} )}_{X} ,$$
wherein δ(X) is a polynomial regarding X,
$$δ ( X ) = {\sum }_{i = 0}^{n - 1} {r}_{i} {X}^{i} , \vert {r}_{i} \vert ( i = 0 , 1 , 2 … ) ,$$
āᵢ and b̅ᵢ being coefficients of polynomials A(X) and B(X), respectively, i being constants.

3. The fast modular multiplication system based on radix transformation according to claim 2, wherein the polynomial modular multiplication layer further comprises:
a grouped multiplication layer, comprising a plurality of adders and multipliers, said grouped multiplication layer configured to perform grouped multiplication processing on the first target polynomials, to obtain a second target polynomial; and
a recombination and reduction layer, comprising a plurality of adders, said recombination and reduction layer configured to perform recombination and reduction processing on the second target polynomial, to obtain a (n−1)-degree polynomial of X.

4. The fast modular multiplication system based on radix transformation according to claim 3, wherein the grouped multiplication layer is further configured to:
transform, through the adders and multipliers built therein, a computing relation in the first target polynomials from constant multiplication to polynomial multiplication, and single multiplication to grouped multiplication, to obtain the second target polynomial.

5. The fast modular multiplication system based on radix transformation according to claim 4, wherein the recombination and reduction layer is further configured to:
perform, through adders built therein, recombination and merging processing on the second target polynomial, to obtain a recombined polynomial;
perform reduction processing on the recombined polynomial, to obtain a reduced polynomial; and
put the reduced polynomial into the initial polynomial of the modulus q for a plurality of times, to obtain the (n−1)-degree polynomial of X.

6. The fast modular multiplication system based on radix transformation according to claim 5, wherein
the second target polynomial is:
$${c}_{i} = {\sum }_{k = 0}^{i} {\overline{a}}_{k} {\overline{b}}_{i - k} ;$$
the recombined polynomial is:
$$C = {\sum }_{i = 0}^{2 n - 2} {c}_{i} {X}^{i \underline{\underline{{t}_{i} = {c}_{i} / k}}} {kX}^{n} {\sum }_{i = 2}^{2 n - 2} {t}_{i} {X}^{i - n} + {\sum }_{i = 0}^{n - 1} {c}_{i} {X}^{i} ;$$
the reduced polynomial is:
$$C mod q ≡ δ ( X ) {\sum }_{i = n}^{2 n - 2} {t}_{i} {X}^{i - n} + {\sum }_{i = 0}^{n - 1} {c}_{i} {X}^{i} ;$$
and
the (n−1)-degree polynomial of X is:
$$C mod q ≡ {\sum }_{i = 0}^{n - 1} {u}_{i} {X}^{i} ,$$
and
wherein uᵢ is a new polynomial coefficient obtained by accumulating terms of the polynomial for a plurality of terms, a bit width of uᵢ is denoted by Nᵤ_{ᵢ} bits, and N<Nᵤ_{ᵢ}<2N; cᵢ is a coefficient of 2M bits; n is a constant; āᵢ is of M bits; b̅ᵢ is a coefficient of M bits, and k is a coefficient of a highest-degree term.

7. The fast modular multiplication system based on radix transformation according to claim 6, wherein each of the iterative reduction sub-layer comprises:
a wiring-mapping layer, configured to perform wiring-mapping processing on the (n−1)-degree polynomial of X; and
an accumulation layer, comprising a plurality of adders, said accumulation layer configured to perform accumulation processing on the (n−1)-degree polynomial of X on which wiring-mapping processing has been performed once.

8. The fast modular multiplication system based on radix transformation according to claim 7, wherein the iterative reduction layer is further configured to:
perform sequentially, through the adders built therein, wiring-mapping processing and accumulation processing on the recombination-and-reduction processed (n−1)-degree polynomial of X for a plurality of times; and
output a third target polynomial in response to the bit widths of coefficients of the (n−1)-degree polynomial of X each being reduced to a required range.

9. The fast modular multiplication system based on radix transformation according to claim 8, wherein the iterative reduction layer is further configured to:
transform the recombination-and-reduction processed (n−1)-degree polynomial of X into a polynomial in a uᵢ form satisfying uᵢ[Nᵤ_{ᵢ}−1:0]=uᵢ[Nᵤ_{ᵢ}−1:L]·(X+1)·2^{L-α}+uᵢ[L−1:0]; and
put the polynomial in the u; form into the initial polynomial of the modulus q and the (n−1)-degree polynomial of X for a plurality of times for reduction, to obtain the third target polynomial satisfying
$$C mod q ≡ {\sum }_{i = 0}^{n - 1} {z}_{i} {X}^{i} = {( {z}_{n - 1} , {z}_{n - 2} , … {z}_{i} , … {z}_{1} , {z}_{0} )}_{X} ,$$

10. The fast modular multiplication system based on radix transformation according to claim 9, wherein the base restoration layer is further configured to:
perform addition and shift operations on the third target polynomial for a plurality of times, to obtain the actual modular multiplication result.
